(19) United States
(12) Patent Application Publication
(10) Pub. No.: US 2026/0204826 A1
(43) Pub. Date: Jul. 16, 2026

(54) CONNECTOR

(71) Applicant: Yazaki Corporation, Tokyo (JP)

(72) Inventors: Kazuhide IKEYA, Makinohara-shi (JP); Mai YOKOYAMA, Makinohara-shi (JP)

(73) Assignee: Yazaki Corporation, Tokyo (JP)

(21) Appl. No.: 19/426,550

(22) Filed: Dec. 19, 2025

(30) Foreign Application Priority Data
Jan. 15, 2025 (JP) 2025-005173

(51) Int. Cl. H01R 13/424

(52) U.S. Cl. CPC H01R 13/424

(57) ABSTRACT

A connector includes: a terminal accommodating member that includes two partition walls partitioning both sides of a terminal, to which an electric wire is connected, together with the one partition wall, an accommodating chamber having an accommodation opening defined by the one partition wall and another partition wall and capable of accommodating the terminal from the accommodation opening, and a terminal lock portion protruding from the one partition wall toward another partition wall and fixing the terminal in the accommodating chamber, and extends in a longitudinal direction of the terminal; a housing that includes a side surface located in a pull-out direction in which the electric wire is pulled out, a housing opening opened in the side surface, and an insertion chamber in which the terminal accommodating member is inserted from the housing opening; and a terminal regulating portion that is located at a position that allows contact with the terminal.

### BACKGROUND OF THE INVENTION

### Field of the Invention

An embodiment of the present invention relates to a connector.

Priority is claimed on Japanese Patent Application No. 2025-005173 filed in Japan on Jan. 15, 2025, the content of which is incorporated herein by reference.

### Description of Related Art

A connector that electrically connects a circuit board or the like of various electronic devices and an electric wire includes a terminal accommodating member that accommodates a terminal to which the electric wire is connected, and a housing into which the terminal accommodating member is inserted. In such a terminal accommodating member, a member for locking a terminal is formed.

For example, Patent Document 1 discloses a connector including a terminal accommodating member in which an accommodating chamber in which a female terminal to which an electric wire is connected is accommodated is formed, and a housing into which the terminal accommodating member is inserted and assembled. In addition, Patent Document 1 discloses that the female terminal accommodated in the accommodating chamber is temporarily locked to the accommodating chamber by the distal end of the female terminal being sandwiched between a regulating portion that regulates an accommodating position of the female terminal and a locking portion that regulates movement of the female terminal to a rear side of the accommodating chamber.

### PRIOR ART DOCUMENT

### Patent Document

Patent Document 1: Japanese Unexamined Patent Application, First Publication No. 2011-14353

### SUMMARY OF THE INVENTION

However, in the technique of Patent Document 1, there is the regulating portion that regulates the accommodating position of the distal end of the female terminal, so that the female terminal needs to be inserted obliquely with respect to the accommodating chamber from above the accommodating chamber, and the female terminal cannot be inserted into the accommodating chamber from directly above. Therefore, it is difficult to achieve automation of wiring such as electric wires.

An embodiment of the present invention is to provide a connector in which automation of wiring is easily achieved.

A connector according to an embodiment of the present invention includes: a terminal accommodating member that includes a first partition wall, a second partition wall facing the first partition wall and partitioning both sides of a terminal, to which an electric wire is connected, together with the first partition wall, an accommodating chamber having an accommodation opening defined by the first partition wall and the second partition wall and capable of accommodating the terminal from the accommodation opening, and a terminal lock portion protruding from the first partition wall toward the second partition wall and fixing the terminal in the accommodating chamber, and extends in a longitudinal direction of the terminal; a housing that includes a side surface located in a pull-out direction in which the electric wire is pulled out, a housing opening opened in the side surface, and an insertion chamber in which the terminal accommodating member is inserted from the housing opening; and a terminal regulating portion that is located at a position that allows contact with the terminal, and regulates the terminal in the accommodating chamber from jumping out from the accommodation opening.

According to the connector according to the embodiment of the present invention, automation of wiring is easily achieved.

### BRIEF DESCRIPTION OF THE DRAWINGS

FIG. 1 is an exploded perspective view illustrating a connector according to an embodiment of the present invention;

FIG. 2 is a side view illustrating a male housing constituting a part of the connector according to the embodiment of the present invention;

FIG. 3 is an enlarged view illustrating a part of the male housing in a frame A of FIG. 2;

FIG. 4 is a side view illustrating a state where a terminal accommodating member is inserted into the male housing of the connector;

FIG. 5 is an enlarged view illustrating a part of the terminal accommodating member and the male housing in a frame B of FIG. 4; and

FIG. 6 is a cross-sectional view taken along line I-I in FIG. 5.

### DETAILED DESCRIPTION OF THE INVENTION

Hereinafter, an embodiment will be described with reference to the drawings. In the following description, constitutions having the same or similar functions are denoted by the same reference numbers. Note that the following embodiment illustrates an example of a representative embodiment of the present invention, and the scope of the present invention is not limited by these descriptions, and various combinations, modifications, and changes can be made within the scope of the gist of the present invention.

### EMBODIMENT

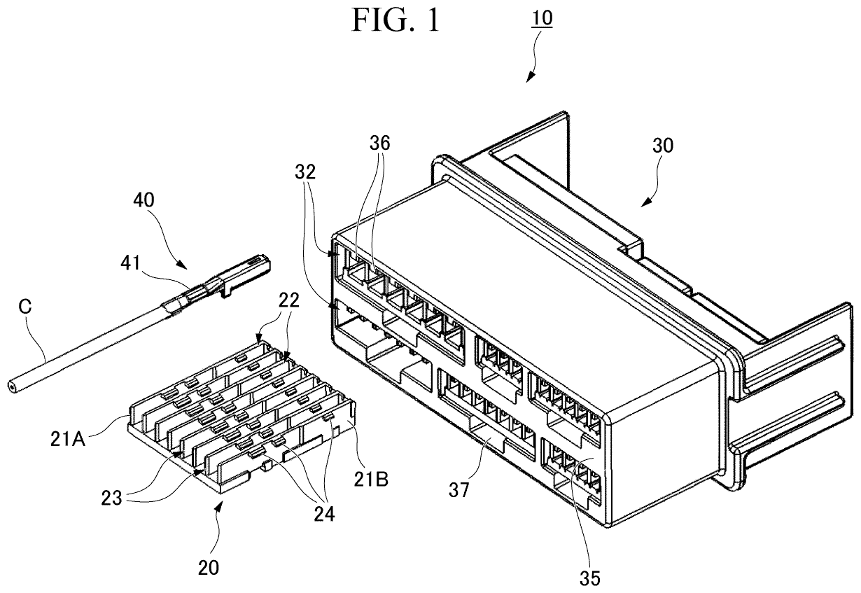

FIG. 1 is an exploded perspective view illustrating a connector 10 according to an embodiment of the present invention. The connector 10 is a female connector that accommodates a female terminal. The connector 10 includes a terminal accommodating member 20 in which a female terminal (hereinafter abbreviated as “female terminal”) 40 to which one end of an electric wire (wire harness) C is connected is mounted, a male housing (housing) 30 into which the terminal accommodating member 20 is inserted and assembled, and a terminal regulating portion 36. For example, the male housing 30 and the terminal regulating portion 36 may be integrally molded.

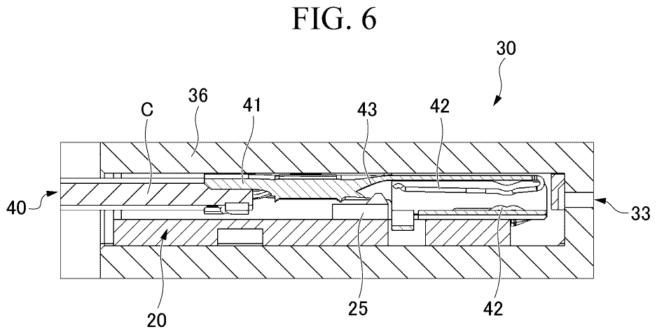

The female terminal (terminal) 40 includes a main body 41 and an electrical contact 42. The electrical contact 42 (see FIG. 6) having a spring property protrudes downward at the front portion of the main body 41, and the electric wire C is connected to the rear portion of the main body 41. Although details will be described later, the female terminal 40 is mounted in an accommodating chamber 23 by being inserted into each terminal accommodating space constituting the accommodating chamber 23 of the terminal accommodating member 20 from directly above in a state before the terminal accommodating member 20 is inserted into the male housing 30.

In addition, the main body 41 has a part (hereinafter, see a recess 43 and FIG. 6) in which an upper surface side of an intermediate portion is recessed in a concave shape, and when the terminal accommodating member 20 is inserted into the male housing 30 to be described later, the recess 43 is engaged with a protrusion 25 (see FIG. 6) provided in the accommodating chamber 23 inside the terminal accommodating member 20. Then, the female terminal 40 is restrained by the terminal accommodating member 20 so as not to move in a front-rear direction.

As illustrated in FIGS. 1 and 5, the terminal accommodating member 20 includes a partition wall 21A (first partition wall), a partition wall 21B (second partition wall), the accommodating chamber 23, and a terminal lock portion 24. The accommodating chamber 23 has an accommodation opening 22. The terminal accommodating member 20 extends in parallel with a longitudinal direction of the female terminal 40. The partition wall 21A and the partition wall 21B are partition walls that partition both sides of the female terminal 40. Each of the partition wall 21A and the partition wall 21B may partition the adjacent female terminals 40, for example. Each of the partition wall 21A and the partition wall 21B extends in parallel with the longitudinal direction of the female terminal 40. The accommodation opening 22 is defined by the partition wall 21A and the partition wall 21B. The accommodating chamber 23 can accommodate the female terminal 40 from the accommodation opening 22.

In the terminal accommodating member 20, seven accommodating chambers 23 for respectively accommodating a plurality of (for example, seven) female terminals 40 to which the electric wires C are connected are formed in a left-right direction (a left-right direction in FIG. 3). In each accommodating chamber 23, the accommodation opening 22 formed above the accommodating chamber 23 in FIG. 5 is opened, and one female terminal 40 can be accommodated from the accommodation opening 22.

The terminal accommodating member 20 is inserted into an insertion chamber 32 to be described later of the male housing 30 after each female terminal 40 is accommodated in each accommodating chamber 23 from a housing opening 31 to be described later formed on a side surface 35 to be described later. The terminal accommodating member 20 is a terminal accommodating plate of a kit-cut type, in which a plurality of accommodating chambers 23 for respectively accommodating a plurality of female terminals 40 are arranged in parallel and connected, and the plurality of accommodating chambers 23 can be cut into a desired number of units for use.

As illustrated in FIGS. 1 and 5, the accommodating chamber 23 refers to each space formed by being partitioned by the partition wall 21A and the partition wall 21B. In the accommodation opening 22 of the accommodating chamber 23, the terminal lock portion 24 that protrudes from the partition wall 21A of the accommodating chamber 23 toward the facing partition wall 21B and fixes a terminal in the accommodating chamber 23 is formed. The terminal lock portion 24 is in contact with the upper portion of the female terminal 40 accommodated in the accommodating chamber 23, thereby preventing the female terminal 40 from coming out of each accommodating chamber 23. The terminal lock portion 24 is made of a bendable material such as plastic.

The upper surface of the terminal lock portion 24 is provided with an inclination from the partition wall 21A toward the facing partition wall 21B, and this inclination makes it easy to accommodate the female terminal 40 in the accommodating chamber 23 from directly above. The terminal lock portion 24 is formed in a part of the accommodation opening 22 formed at the upper end of the partition wall 21A, and is formed, for example, at a central portion of the accommodation opening 22 in a direction in which the partition wall 21A extends. By forming the terminal lock portion 24 at the central portion of the accommodation opening 22, the female terminal 40 can be more easily accommodated in the accommodating chamber 23 from directly above. In addition, a plurality of the terminal lock portions 24 can be formed at the upper end of the partition wall 21A, and this constitution can enhance prevention of the female terminal 40 from coming out of the accommodating chamber 23.

As illustrated in FIGS. 5 and 6, the protrusion 25 that engages with the recess 43 of the female terminal 40 is provided at a bottom in the accommodating chamber 23. With this constitution, the female terminal 40, after being accommodated in the accommodating chamber 23, can be restrained to prevent movement in the front-rear direction in which the partition wall 21A and the partition wall 21B extend.

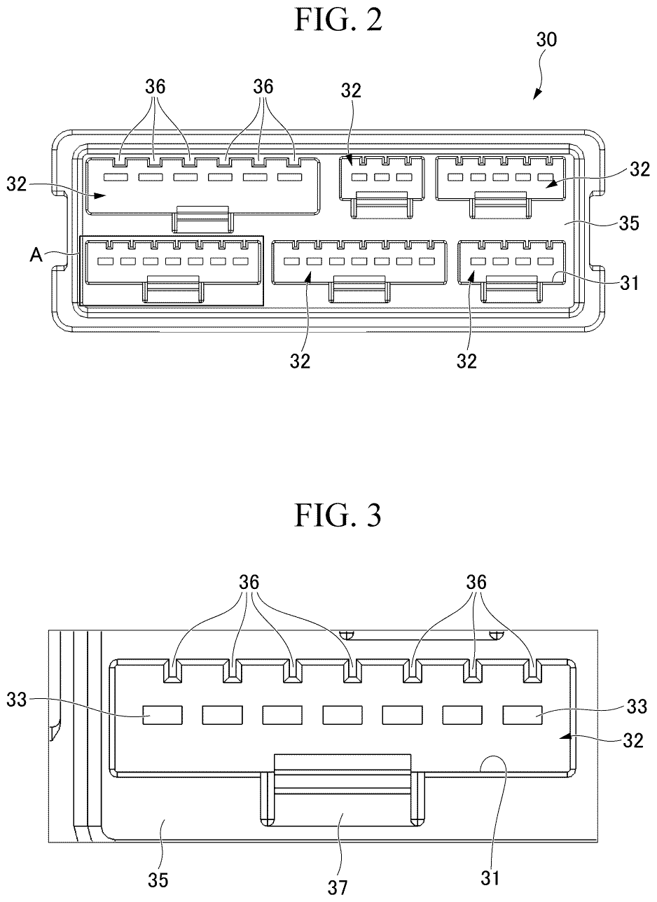

As illustrated in FIGS. 1 to 5, the male housing 30 includes the housing opening 31 and the insertion chamber 32. The male housing 30 has the side surface 35. In the male housing 30, the side surface 35 is located in a pull-out direction (the direction from the back to the front of the plane of FIGS. 2 to 5) in which the electric wire C is pulled out from the male housing 30. The housing opening 31 is on the front side in the pull-out direction in which the electric wire C is pulled out from the male housing 30. The housing opening 31 is open at the side surface 35. The terminal accommodating member 20 is inserted into the insertion chamber 32 from the housing opening 31.

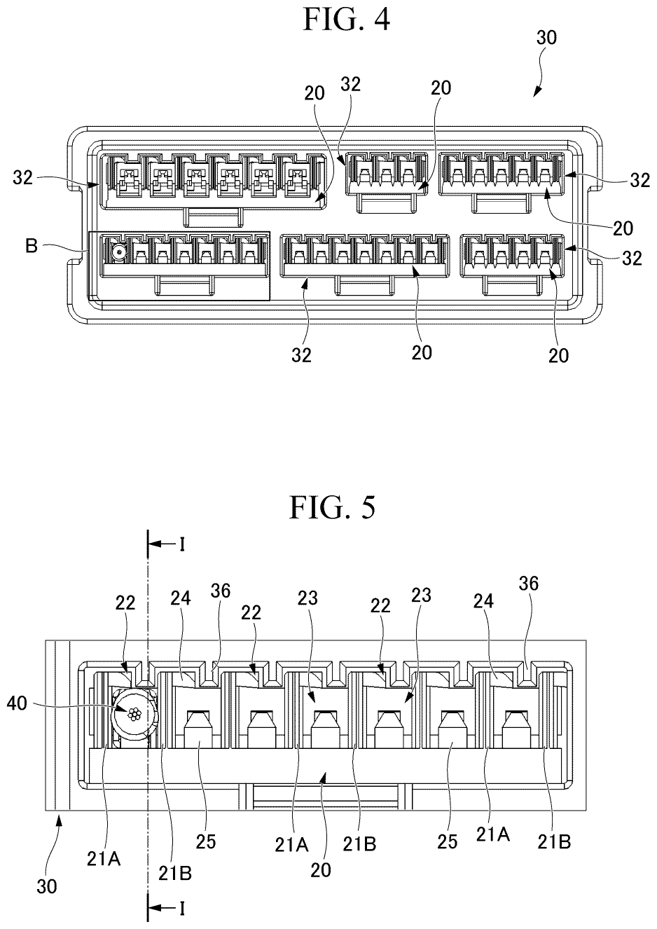

The male housing 30 has a plurality of insertion chambers 32 in which the terminal accommodating members 20 are arranged and inserted. The plurality of insertion chambers 32 are arranged in vertical and horizontal directions (vertical and horizontal directions toward the plane of FIGS. 2 and 4), and the terminal accommodating members 20, each having a different number of accommodating chambers 23, are inserted into the insertion chambers 32, respectively. Note that the terminal accommodating members 20 may have the same number of accommodating chambers 23.

In addition, in the male housing 30, the same number of terminal holes 33 as that of the accommodating chambers 23 of the terminal accommodating member 20 are provided on the back side of the side surface 35 facing the front side where the housing opening 31 is formed. With this constitution, a distal end part of a male terminal (not illustrated) provided in a male connector (not illustrated) can be fitted into the terminal hole 33 and engage with the electrical contact 42 provided at the distal end portion of the female terminal 40. Furthermore, the side surface 35 on the back surface side abuts on the distal end of the female terminal 40 accommodated in the accommodating chamber 23 of the terminal accommodating member 20, thereby preventing the female terminal 40 from being removed from the accommodating chamber 23.

The terminal regulating portion 36 that regulates the female terminal 40 in the accommodating chamber 23 of the inserted terminal accommodating member 20 from jumping out from the accommodation opening 22 is formed at a position, in contact with the accommodation opening 22, in the inner upper portion of the male housing 30 (upward toward the plane of FIGS. 2 to 5). The terminal regulating portion 36 protrudes to a position that allows contact with the female terminal 40. The terminal lock portion 24 is formed in a part of the accommodation opening 22. The terminal regulating portion 36 protrudes toward the accommodation opening 22 of the partition wall 21B facing the partition wall 21A where the terminal lock portion 24 is formed. The terminal regulating portion 36 protrudes to a position closer to the partition wall 21B, relative to the partition wall 21A in which the terminal lock portion 24 is formed, of the partition wall 21A and the partition wall 21B facing each other. The terminal regulating portion 36 can regulate the female terminal 40 from moving to the outside of the accommodating chamber 23 while reducing a locking member on the terminal accommodating member 20 side.

In addition, the terminal regulating portion 36 is formed with an inclination that widens from the housing opening 31 toward the back side in the extending direction of the insertion chamber 32. With this constitution, the female terminal 40 can be easily inserted into the insertion chamber 32 while being in contact with the terminal regulating portion 36. Note that the terminal regulating portions 36 and the terminal lock portions 24 may be formed so as to be alternately arranged in the extending direction of the accommodating chamber 23.

On the bottom surface portion of the insertion chamber 32, a guide groove 37 into which a human hand or the like can be inserted when the inserted terminal accommodating member 20 is pulled out is formed to extend in the pull-out direction. With this constitution, the terminal accommodating member 20 can be easily pulled out from the insertion chamber 32 without using a tool.

### (Accommodating Procedure of Female Terminal 40)

Next, an operation procedure when the female terminal 40 is mounted and accommodated in the connector 10 of the present embodiment will be described with reference to FIGS. 1 to 6.

Firstly, the female terminal 40 is brought close to the accommodation opening 22 of the accommodating chamber 23 in a direction parallel to the extending direction of the accommodating chamber 23 (the left-right direction in FIG. 6) from directly above the accommodating chamber 23 of the terminal accommodating member 20.

Secondly, when the female terminal 40 is brought close to the accommodation opening 22, the female terminal 40 abuts on the terminal lock portion 24 formed in the accommodation opening 22, so that the female terminal 40 is directly pressed against the terminal lock portion 24 from directly above in the same parallel direction.

Thirdly, when the female terminal 40 is pressed against the terminal lock portion 24, the terminal lock portion 24 is bent, and the female terminal 40 is accommodated in the accommodating chamber 23. When the female terminal 40 is accommodated in the accommodating chamber 23, the terminal lock portion 24 returns to an original position, and the female terminal 40 is locked from above by the terminal lock portion 24. Furthermore, the recess 43 of the female terminal 40 and the protrusion 25 in the accommodating chamber 23 are engaged with each other, and the female terminal 40 is also prevented from moving in the extending direction of the accommodating chamber 23.

Fourth, the terminal accommodating member 20 in which the female terminal 40 is accommodated in the accommodating chamber 23 is inserted into the insertion chamber 32 from the housing opening 31, and engaged and fixed to the insertion chamber 32. When the fixing is performed, the terminal regulating portion 36 protruding from the upper portion of the inner wall of the insertion chamber 32 toward the lower bottom is located closer to the partition wall 21B, relative to the partition wall 21A in which the terminal lock portion 24 is formed, of the partition wall 21A and the partition wall 21B facing each other. With this constitution, it is possible to prevent the female terminal 40 from jumping out from the accommodating chamber 23 even in a part of the accommodation opening 22 where the terminal lock portion 24 is not formed.

### (Effects of Present Embodiment)

As a comparative example when the terminal is accommodated in the accommodating chamber, there is a case where a female terminal is inserted obliquely into the accommodating chamber from above the accommodating chamber as disclosed in Patent Document 1. In addition, there is also a two-stage accommodating process in which the terminal is partially inserted into the accommodating chamber from above the accommodating chamber, and then the terminal is slid in the longitudinal direction of the accommodating chamber to be set at a normal position.

In the case of the comparative example, the terminal cannot be easily accommodated in the accommodating chamber, and it is difficult to perform wiring automation of the electric wire.

In contrast to the above-described comparative example, the connector 10 according to the present embodiment includes the accommodating chamber 23 capable of accommodating the female terminal 40 from the accommodation opening 22. With this constitution, the female terminal 40 can be easily accommodated in the accommodating chamber 23. In addition, the connector 10 according to the present embodiment includes the terminal lock portion 24 and the terminal regulating portion 36. With this constitution, a vertical play of the female terminal 40 can be suppressed and vibration resistance can be improved, so that contact reliability can be secured. Further, it is possible to regulate the female terminal 40 in the accommodating chamber 23 of the inserted terminal accommodating member 20 from jumping out from the accommodation opening 22. In addition, for example, when a member such as the regulating portion is not formed at a location where the distal end portion of the female terminal 40 of the terminal accommodating member 20 is accommodated, the female terminal 40 can be accommodated in one process while maintaining a parallel direction from directly above the accommodating chamber 23. Therefore, the automation of wiring is easily achieved.

In the connector 10, the terminal lock portion 24 is formed in a part of the accommodation opening 22. The terminal regulating portion 36 protrudes to a position closer to the partition wall 21B, relative to the partition wall 21A in which the terminal lock portion 24 is formed, of the partition wall 21A and the partition wall 21B facing each other. With these constitutions, it is possible to avoid contact between the terminal lock portion 24 and the terminal regulating portion 36, and to prevent the female terminal 40 from jumping out from the accommodating chamber 23 even in a part of the accommodation opening 22 where the terminal lock portion 24 is not formed. In addition, since the terminal lock portion 24 is located in the partition wall 21A on one side, it is possible to secure a space in which the terminal lock portion 24 is bent when the female terminal 40 is inserted. Furthermore, since the terminal regulating portion 36 is formed, the locking member on the terminal accommodating member 20 side can be reduced.

In addition, in the connector 10, the terminal lock portion 24 is formed at the central portion of the accommodation opening 22 in a direction in which the partition wall 21A extends. With this constitution, the female terminal 40 can be easily accommodated in the accommodating chamber 23 from directly above as compared with a case where the terminal lock portion 24 is formed at the end of the accommodation opening 22 in the direction in which the partition wall 21A extends.

In addition, in the connector 10, the terminal accommodating member 20 has the plurality of accommodating chambers 23 that respectively accommodate the plurality of female terminals 40. The male housing 30 has the plurality of insertion chambers 32 in which the terminal accommodating members 20 are arranged and inserted. With these constitutions, various kinds of wire harnesses can be collectively used in one connector 10.

In addition, in the connector 10, the terminal accommodating member 20 can be formed as a terminal accommodating plate of a kit-cut type, in which a plurality of accommodating chambers for respectively accommodating a plurality of terminals are arranged in parallel and connected, and the plurality of accommodating chambers can be cut into a desired number of units for use. With this constitution, the connector 10 can be utilized according to the number of female terminals 40 required and the application.

In the above embodiment, the connector 10 includes the male housing 30 as a housing. However, the connector 10 may include any housing. As a modification, the connector 10 may include a female connector as a housing instead of the male housing 30.

In the above embodiment, the female terminal 40 as a terminal is mounted in the terminal accommodating member 20. However, any terminal may be mounted in the terminal accommodating member 20. As a modification, instead of the female terminal 40, a male terminal may be mounted as a terminal in the terminal accommodating member 20.

The terminal accommodating member 20 includes the partition wall 21A as the first partition wall and a second partition wall 21B as the second partition wall. However, either may be the first partition wall and either may be the second partition wall. As a modification, the terminal accommodating member 20 may include the partition wall 21A as the second partition wall and the second partition wall 21B as the first partition wall.

In the above embodiment, the terminal accommodating member 20 includes the partition wall 21A as the first partition wall and the second partition wall 21B as the second partition wall. However, either may be the first partition wall and either may be the second partition wall. As a modification, the terminal accommodating member 20 may include the partition wall 21A as the second partition wall and the second partition wall 21B as the first partition wall.

Several embodiments and modifications have been described above. However, the embodiments and the modifications are not limited to the examples described above. For example, the embodiments and the modifications may be implemented in combination with each other.

### REFERENCE SIGNS LIST

10 connector
20 terminal accommodating member
21A partition wall (first partition wall, second partition wall)
21B partition wall (second partition wall, first partition wall)
22 accommodation opening
23 accommodating chamber
24 terminal lock portion
25 protrusion
30 male housing (housing)
31 housing opening
32 insertion chamber
33 terminal hole
35 side surface
36 terminal regulating portion
37 guide groove
40 female terminal (terminal)
41 main body
42 electrical contact
43 recess
C electric wire

What is claimed is:

1. A connector comprising:
a terminal accommodating member that includes:
a first partition wall;
a second partition wall facing the first partition wall and partitioning both sides of a terminal, to which an electric wire is connected, together with the first partition wall;
an accommodating chamber having an accommodation opening defined by the first partition wall and the second partition wall and capable of accommodating the terminal from the accommodation opening; and
a terminal lock portion protruding from the first partition wall toward the second partition wall and fixing the terminal in the accommodating chamber, wherein the terminal accommodating member extends in a longitudinal direction of the terminal;
a housing that includes:
a side surface located in a pull-out direction in which the electric wire is pulled out;
a housing opening opened in the side surface; and
an insertion chamber in which the terminal accommodating member is inserted from the housing opening; and
a terminal regulating portion that is located at a position that allows contact with the terminal, and regulates the terminal in the accommodating chamber from jumping out from the accommodation opening.

2. The connector according to claim 1, wherein
the terminal lock portion is provided in a part of the accommodation opening, and
the terminal regulating portion protrudes to a position closer to the second partition wall relative to the first partition wall.

3. The connector according to claim 2, wherein
the terminal lock portion is formed at a central portion of the accommodation opening in a direction in which the first partition wall extends.

4. The connector according to claim 1, wherein
the terminal has a plurality of terminals,
the accommodating chamber has a plurality of accommodating chambers that respectively accommodate the plurality of terminals, and
the insertion chamber has a plurality of insertion chambers in which the terminal accommodating members are arranged and inserted.

5. The connector according to claim 4, wherein
the terminal accommodating member is a terminal accommodating plate of a kit-cut type, in which the plurality of accommodating chambers accommodating the plurality of terminals are arranged in parallel and connected, and the plurality of accommodating chambers are able to be cut into a desired number of units for use.
